(19) United States
(12) Patent Application Publication
(10) Pub. No.: US 2007/0290659 A1
(43) Pub. Date: Dec. 20, 2007

(54) D.C. power supply with high efficiency output control

(76) Inventor: Ronald M. Bormann, McAllen, TX (US)

Correspondence Address: JOHN F. BRYAN, 8291 LAKESIDE DRIVE, ENGLEWOOD, FL, 34224, US

(21) Appl. No.: 11/454,279

(22) Filed: Jun. 17, 2006

(51) Int. Cl. G05F 1/00

(52) U.S. Cl. 323/222

(57) ABSTRACT

A preferred method for controlling the current output of a D.C. voltage source over a broad range, according to the present invention, switches the current supplied by the D.C. source “off” and “on” at a controlled frequency as it is passed through an inductor, so that the flow is impedance limited and controlled by increasing or decreasing the frequency rate, so as to reduce or increase the current flow and power output available to drive a power dissipating load.

### TECHNICAL FIELD

The present invention relates generally to the field of D.C switching power supplies and more particularly, to such power supplies as are adapted to provide accurate control of the output voltage over a broad range.

### BACKGROUND

Direct Current (DC) switching power supplies are generally used to provide electrical power for applications requiring an essentially constant input voltage. There are however, applications such as the operation of a thermoelectric cooling element (TEC) which benefit greatly in performance and efficiency through the use of controlled, variable voltage DC. Power efficiency is of prime importance. Another characteristic required is that there be less than 10% AC ripple, inasmuch as excessive ripple damages TECs and reduces efficiency.

Various rectifying DC power circuits are extant in the prior art. The most basic DC supply, in which a bridge rectifier and filter capacitors change AC into pure DC output, does not contemplate any form of voltage control (regulation). A well-known regulation technique utilizes a Pulse Width Modulator (PWM) and a Metal Oxide Semiconductor Field Effect Transistor (MOSFET). The MOSFET is a very fast voltage controlled switch, turning on and off in a matter of nanoseconds. The square wave from the PWM applies the controlling signal, so that when the MOSFET is switched “On”, current flows through it and when it is “Off”, flow is blocked. Output is varied by the relative lengths of MOSFET “On time” and “Off time”. At 25% Off-time and 75% “On-time” output would be toward the high end and at 75% “Off time” output would be toward the low end.

There are also semi-resonant power supplies that use a frequency variation to control output. These are based on the fact that an inductor and capacitor balanced to resonate at a given frequency will offer almost no impedance to the flow of electricity and yet have a very sharp change in impedance when the drive frequency is shifted slightly. These units are useful for voltage regulation over no more than a 5% to 15% range.

When overall electrical efficiency is of primary importance, there is no prior art DC switching power supply that offers a usable output voltage ranging from zero volts to its maximum drive capacity. This ability is particularly critical to refrigeration applications where sufficient power must be available to cool the contents quickly from room temperature and yet have the ability to drive efficiently at a power level low enough to just barely offset heat leakage back into the refrigerated area. Output voltage control must be capable of smoothly ramping up and down, since The abrupt on & off control, such as provided by a simple thermostatic switch, can cause thermal shock, resulting in TEC failure.

A first object of the present invention therefore, is to provide an AC rectifying, DC power supply capable of output voltage regulation ranging from zero volts to its maximum drive capacity. A second object is that this DC power supply be capable of smooth, incremental voltage regulation across this full range. A third object is that the overall electrical efficiency of rectification and regulation be superior to similar prior art power supplies. Fourth and final objects are that the DC power supply of the present invention have less than 10% AC ripple and utilize readily available and inexpensive components throughout.

### SUMMARY OF THE INVENTION

The present invention relates to or employs some steps and apparatus well known in the electrical arts and therefore, not the subject of detailed discussion herein. This invention addresses the aforesaid objectives in a preferred embodiment employing some familiar, uncomplicated technology.

As a simplified description, a preferred embodiment of the present invention has D.C. voltage input to a Metal Oxide Semiconductor Field Effect Transistor or MOSFET, a very fast voltage controlled switch capable of turning on and off in a matter of nanoseconds. The unique aspect of the present invention lies in the wide range frequency input to the MOFSET by a Voltage-Frequency converter circuit. For example, when a power supply of the present invention is used to drive TECs for refrigerating an enclosure, the lowest internal temperature the refrigerated enclosure should reach (set point) is controlled by a variable resistor. A sensor, in this case a thermistor, senses the actual enclosure temperature. If the temperature is higher than the set point, the MOSFET switching frequency is decreased, reducing the impedance of the inductor and allowing the TEC drive current flowing through the inductor to increase. As the thermistor comes down to a temperature 5-8 degrees above the set-point, the switching frequency is gradually increased. Impedance of the inductor is consequently increased to ramp down current flow for the TEC drive. Then, as the temperature reaches the set point, switching frequency becomes higher still, so that only enough current to offset thermal leakage passes through the inductor. Thus, the set point temperature is maintained. The circuit is also “fail safe” in the sense that a sensor failure (open circuit) will reduce the power output to a minimum, rather than allow a “runaway” condition.

### BRIEF DESCRIPTION OF THE DRAWINGS

The accompanying drawings are incorporated into the specification to assist in explaining the present invention. The drawings illustrate preferred and alternative examples of how the invention can be made and used and are not to be construed as limiting the invention to only those examples illustrated and described. The various advantages and features of the present invention will be apparent from a consideration of the drawings in which:

FIG. 1 is a schematic diagram showing a prior art circuit for a rectified D.C voltage supply;

FIG. 2 is a schematic diagram showing a preferred embodiment of the power supply of the present inventions;

FIG. 3A is a representation of the voltage waveform of the MOSFET output at low frequencies;

FIG. 3B is a representation of the inductor current waveform at the low frequency of FIG. 3A;

FIG. 3C is a representation of the voltage waveform of the MOSFET output at high frequencies;

FIG. 3D is a representation of the inductor current waveform at the high frequency of FIG. 3C;

### DETAILED DESCRIPTION OF THE DRAWINGS

The present invention is described in the following by referring to drawings of examples of how the invention can be made and used. In these drawings, reference characters are used throughout the views to indicate corresponding parts. The embodiment shown and described herein is exemplary. Many details are well known in the art, and as such may be neither shown nor described.

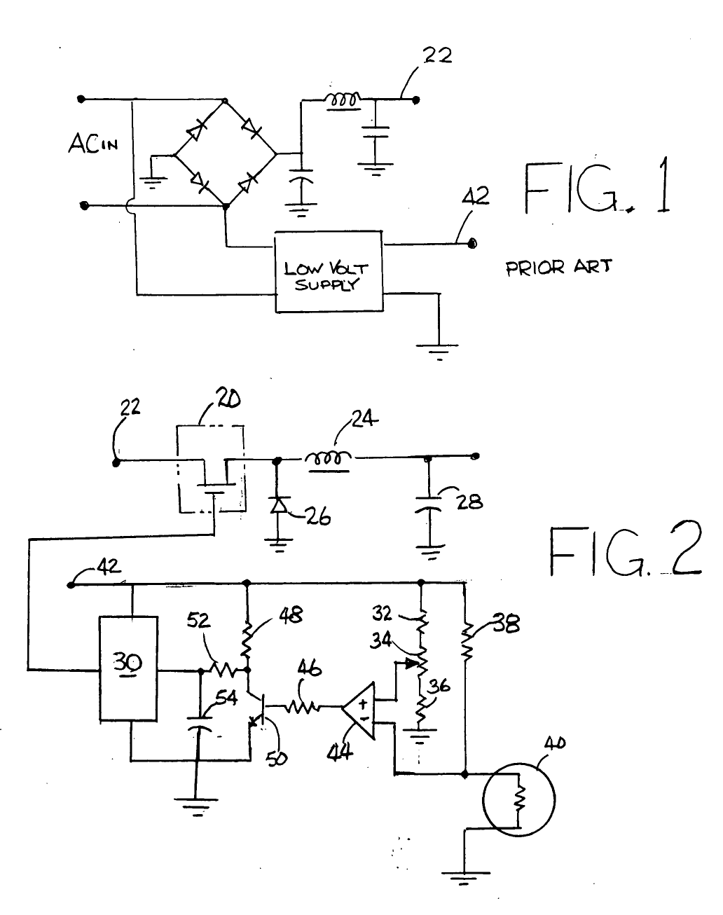

FIG. 1 shows a prior art circuit for rectifying 120VAC as one possible supply means of supplying D.C. buss 22 and 12VDC line 42.

In FIG. 2, a preferred embodiment 10 of this invention shows a way of utilizing MOSFET 20 to provide a regulated power supply with the desired operating characteristics for driving a power dissipating load. DC power supplies having these same characteristics are useful for other applications however, this example of a drive for TEC's shows a particularly useful embodiment of the present invention. The circuit components and their function is best understood by reference to the waveforms of the following figures.

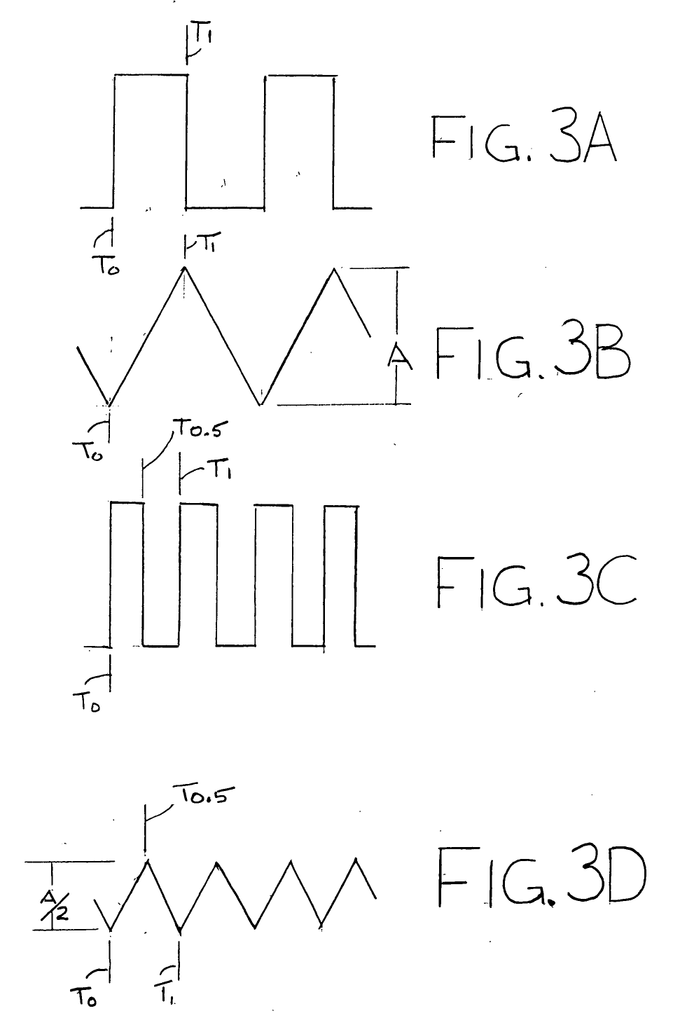

FIG. 3A is a representation of the voltage waveform of the MOSFET output at low frequencies. When MOSFET 20 is switched on at T_{O} the voltage across inductor 24 immediately jumps from “zero” to the full voltage of rectified D.C. buss 22 and remains at that level until T₁ During this time, the reversed bias of diode 26 blocks current flow to ground and current flowing in inductor 24 creates a growing magnetic field. As shown by FIG. 3B, at the same T_{O}, current flow starts to increase from “zero”. As the current rise, the growing magnetic field cutting across the turns of wire forming inductor 24 generates a voltage opposing the input voltage. In this manner, the impedance of inductor 24 limits current to a linear rate of increase throughout the “on” cycle, up to amplitude A, until MOFSET 20 is switched “off” at T₁ Thus, current can flow from D.C. buss 22 to charge filter capacitor 28 only during “on” cycle and can only rise to the rate limited level allowed by the “on” cycle duration. When MOSFET 20 is switched “off” at T₁, the magnetic field around inductor 24 begins to collapse. The polarity at diode 26 changes to provide a ground connection as inductor 24 converts this shrinking magnetic field into continued current flow for charging filter capacitor 28.

MOSFET 20 switches “on” and “off”, such that filter capacitor 28 is alternately charged by DC buss 22 and then, by inductor 24. By varying the amount of cycle time that D.C. buss 22 is “on” and averaging the voltage over time, the circuit of FIG. 2 can provide high efficiency power regulation. When the “on” and “off” switching cycle is imposed at a higher frequency, doubled as shown at T_{O} and T_{0.5} and between T_{0.5} and T₁, the duration is proportionately shorter, so that amplitude A/2 is half of amplitude A. It is readily shown that average output is also reduced inversely, by a factor of two. In this manner, since MOFSET 20 is either fully “on” or fully “off”, the difference between input and output power is not be dissipated as heat and very high efficiency is achieved at all output levels.

The circuit description is somewhat similar to a “Single Ended Primary Inductor Circuit” or SEPIC, switching power supply. In a SEPIC however, a fixed switching frequency is chopped into pulses, which are varied in width to control power output.

A major problem in many attempts to provide a wide range of regulation arises when input is applied to an inductor (24) beyond the point of saturation. Once saturation is reached, the magnetic field can no longer increase to generate opposing electric flow. the Inductor then becomes a dead short, causing a catastrophic circuit failure or tripping a circuit breaker. Thus, the optimum “on/off” cycle time for Voltage-Frequency converter 30 is around 50%/50%, so that output is supported by current flow from D.C. buss 22 for the first half-cycle and by collapse of the magnetic field around inductor 24 to generate current flow for the second half-cycle.

Control operation is as follows: Referring back to FIG. 2, resistors 32, 34 and 36, connected to 12VDC line 42, create a “temperature set point reference voltage” which is adjusted at variable resistor 34 and applied to Op Amp 44 non-inverting (+) input. Thermistor 40 is inside an unshown refrigerated enclosure. When hot, thermistor 40 has less resistance than at room temperature, which, along with resistor 38, cause the voltage applied to Op Amp 44 inverting (−) input to become lower. The output of Op Amp 44 depends on the difference between its inputs (inverting and non-inverting) and the amount of gain the circuit is wired for. As the inverting input becomes lower (less positive) the output of Op Amp 44 increases (becomes more positive). Resistor 46 is current limiting, to protect Op Amp 44, which can take no more than 50 milli-amperes, and also sets the base drive current for transistor 50. The voltage drop across resistor 48 and fed to resistor 52 determines the collector load for transistor 50. Transistor 50 serves as a buffer and inverter giving a decreasing input to Voltage-Frequency converter 30, an integrated circuit such as the LM331 made by National Semiconductor. This decreases the switching frequency to MOSFET 20. The control of frequency input to MOFSET over a wide range as a means of controlling power output is the unique aspect of the present invention. Since inductor 24 has less resistance to electrical current flow (impedance) at lower frequencies, the TEC drive voltage increases, so as to provide a higher heat transfer rate and cool the refrigerated enclosure. Thus, thermistor 40 is cooled, gradually reducing the drive to the TEC's. Eventually, as the interior temperature approaches and reaches the “set point reference temperature” this process will settle. Gain of Op Amp 44 can be set such that, if the temperature is greater than 5-8 degrees above the set point, the TECs receive full drive, but once the temperature gets within 5-8 degrees of set point, the circuit gradually reduces the drive (ramps down). This reduces thermal stress on the Tec's and helps the unit to settle at the proper temperature more rapidly. Resistors 48 and 46 and transistor 50 prevent loading of the sensing circuit, so as to deliver a strong signal to Voltage-Frequency converter 30. Resistor 52 and capacitor 54 serve to soften the effect of sudden TEC drive changes, such as upon start-up, also to reduce thermal stress or shock on the TEC's.

The embodiments shown and described above are exemplary. It is not claimed that all of the details, parts, elements, or steps described and shown were invented herein. Even though many characteristics and advantages of the present inventions have been described in the drawings and accompanying text, the description is illustrative only. Changes may be made in the detail, especially in matters of shape, size, and arrangement of the parts within the scope and principles of the inventions. The restrictive description and drawings of the specific examples above do not point out what an infringement of this patent would be, but are to provide at least one explanation of how to use and make the inventions. The limits of the inventions and the bounds of the patent protection are measured by and defined in the following:

I claim:

1. A method for controlling the current output of a D.C. voltage source, ranging from a low level approaching zero, up to the level of maximum capacity, comprising the steps of:
providing a D.C. voltage source and connecting the output thereof to the input of an inductor;
connecting the current flowing through the inductor to a power-dissipating load;
switching the D.C. voltage connected to the inductor “off” and “on” at a controlled frequency rate;
reducing current flow to the power dissipating load to any selected level above zero by increasing the frequency rate; and
increasing current to the power-dissipating load to any selected level up to maximum capacity by decreasing the frequency rate.

2. The method for controlling the current output of a D.C. voltage source according to claim 1 and further comprising the steps of:
generating a switching frequency by using a voltage/frequency converting circuit;
applying the switching frequency so generated as the controlling signal to switch a high-speed switching device “off” and “on” at the controlled frequency rate; and
controlling the switching frequency by a voltage signal responsive to the power dissipating load condition.

3. The method for controlling the current output of a D.C. voltage source according to claim 1, wherein the “off” and “on” switching is implemented by a Metal Oxide Semiconductor Field Effect Transistor or “MOSFET”.

4. The method for controlling the current output of a D.C. voltage source according to claim 1, wherein the power dissipating load comprises least one thermoelectric cooling device.

5. The method for controlling the current output of a D.C. voltage source according to claim 2, wherein the power dissipating load comprises at least one thermoelectric cooling device and the power dissipating load condition is sensed by a sensor operating so as to provide a voltage signal responsive to that condition.

6. A method for controlling the current output of a D.C. voltage source, ranging from a low level approaching zero, up to the level of maximum capacity, comprising the steps of:
providing a D.C. voltage source and connecting the output thereof to the input of an inductor;
connecting the current flowing through the inductor to a power-dissipating load;
switching the D.C. voltage connected to the inductor “off” and “on” at a controlled frequency rate so as to limit current flow through the inductor;
determining the power level demanded for the power-dissipating load;
reducing current flow to the power dissipating load to meet a lower power demand, by increasing the frequency rate; or
increasing current flow to the power-dissipating load to meet a higher power level demand, by decreasing the frequency rate.

7. The method for controlling the current output of a D.C. voltage source according to claim 6, and further comprising the steps of:
generating a switching frequency by using a voltage-frequency converting circuit;
applying the switching frequency so generated as the controlling signal for switching a high-speed switch “off” and “on” at the controlled frequency rate; and
controlling the switching frequency by a voltage signal responsive to the power dissipating load condition.

8. The method for controlling the current output of a D.C. voltage source according to claim 6, wherein the “off” and “on” switching is implemented by a Metal Oxide Semiconductor Field Effect Transistor or “MOSFET”.

9. The method for controlling the current output of a D.C. voltage source according to claim 6, wherein the power dissipating load comprises least one thermoelectric cooling device.

10. The method for controlling the current output of a D.C. voltage source according to claim 7, wherein the power dissipating load comprises at least one thermoelectric cooling device and the power demand level is sensed by a thermistor operating so as to provide a voltage signal responsive to that condition.
